(19) United States
(12) Patent Application Publication
(10) Pub. No.: US 2020/0159380 A1
(43) Pub. Date: May 21, 2020

(54) INTUITIVE VISUALIZATION OF EVENT BASED DATA

(71) Applicant: Cisco Technology, Inc., San Jose, CA (US)

(72) Inventors: Jayesh Kantilal Wadikar, Milpitas, CA (US); Vishv Rohitkumar Brahmbhatt, Union City, CA (US); Shraddha Herlekar, San Jose, CA (US); Vivek Prahladbhai Parekh, Santa Clara, CA (US); Pok Sze Wong, Santa Clara, CA (US)

(21) Appl. No.: 16/368,569

(22) Filed: Mar. 28, 2019

Related U.S. Application Data
(60) Provisional application No. 62/770,127, filed on Nov. 20, 2018.

(51) Int. Cl. G06F 3/0485; G06F 3/0484; G06F 3/0481

(52) U.S. Cl. CPC G06F 3/0485; G06F 2203/04803; G06F 3/0481; G06F 3/04842

(57) ABSTRACT

The present invention is directed to a novel user interface for displaying event-based data with visual rendering of the chronological arrangement and relationship among various event. The disclosed user interface utilizes a scroll feature for traversing along a time axis with various network related messages and events displayed as panels views along the scroll range. The described user interface framework enables visual displaying of event-based data in an intuitive format that may be rendered across small and large display sizes. The disclosed technology further provides for a depiction of dependencies, cause and effect relationships, data flow, event attributes and chronological ordering in a same view.

### CROSS-REFERENCE TO RELATED APPLICATIONS

This application claims priority to U.S. Provisional Patent Application No. 62/770,127, filed on Nov. 20, 2018, the content of which is incorporated herein by reference in its entirety.

### TECHNICAL FIELD

The present technology pertains to systems and methods for monitoring and processing network related data. More specifically it is directed to graphical representation of network-related events.

### BACKGROUND

A network administrator may be required to review large volumes of time series data for events occurring in the network system. For example, conducting a software compliance audit may require reviewing of all the network events activities and audit records, occurring over a period of time, in a chronological order, in addition to examining various attributes associated with the network events such as IP ranges, device identifiers, users and workflows. A network administrator may further need to view commands that were run on a specific set of devices and correlate the events that have occurred over a period of time. The conventional two-dimensional chart-based representation of audit logs and network events makes it very difficult for a network operator to effectively examine all relevant data to, for example, identify correlations and chronological features in the data. This would be even more difficult when using small screen sizes provided with smartphones and tablets.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example visual representation of network events and related data along a bi-directionally scrollable time axis, in accordance with some embodiments of the present technology.

FIG. 2 illustrates an example visual representation of network events and related data along a bi-directionally scrollable time axis, in accordance with some embodiments of the present technology.

FIG. 3 illustrates a low-level view of a network event accessed by clicking on the appropriate panel view representation of a network related event, in accordance with some embodiments of the present technology.

FIG. 4 illustrates a time perspective feature provided by a user interface utilizing a network event visualization scheme, in accordance with some embodiments of the present technology.

FIG. 5 illustrates a time perspective feature and visual cause and effect indicators provided by a network monitoring user interface, in accordance with some embodiments of the present technology.

FIG. 6A illustrates a network event monitoring interface with a time dimension to provide a temporal perspective on related network events, in accordance with some embodiments of the present technology.

FIG. 6B illustrates a live streaming feature of a User Interface for monitoring and troubleshooting a current state of a network in real time, in accordance with some embodiments of the present technology.

FIG. 7 illustrates an example of a physical topology of an enterprise network in accordance with some embodiments of the present invention.

FIG. 8 illustrates an example of a logical architecture for an enterprise network, in accordance with some embodiments of the present invention.

FIG. 9 illustrates an example of a physical topology for a multi-site enterprise network, in accordance with some embodiments of the present invention.

FIG. 10 illustrates an example network device, in accordance with some embodiments of the present technology.

FIG. 11 illustrates an example architecture of a computing device, in accordance with some embodiments of the present technology.

### DESCRIPTION OF EXAMPLE EMBODIMENTS

Various example embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Disclosed are systems, methods, and computer-readable media for intuitive representation of network-related data using graphical features across a multi-dimensional visual field to concurrently provide information on various aspects related to network activity and network-related events.

In some aspects of the present technology, a method includes depicting at least two network event as at least two card-based or panel views, along a common time axis, wherein the common time axis is visually represented by an extension of a two-dimensional display plane along a third mutually orthogonal spatial plane, and wherein the at least two card-based or panel views are disposed along the common time-axis in accordance with an occurrence time of the at least two network events.

In some aspects of the present technology, a system includes one or more processors and at least one computer-readable storage medium with stored instructions, which when executed by the one or more processors cause the one or more processors to generate two or more card-based or panel views corresponding to two or more network related events, wherein at least one panel view has one or more textual and graphical elements for conveying one or more descriptions for a respective one of the two or more network related events; display the two or more card-based or panel views each corresponding to a respective one of the two or more network events, along a common (bi-directionally scrollable) time axis, wherein the common time axis is visually represented as an extension of a two-dimensional display area along a third mutually orthogonal spatial dimension (z-axis); dispose the two or more panel views, along the common time axis in accordance with an occurrence time of the corresponding network related event; and depict one or more temporal relationships among the two or more network related events by using one or more visual indicators between corresponding card-based views disposed along the common time axis.

In accordance with some embodiments of the present technology, a user experience of navigating between the at least two panel views disposed along the common time axis may be visually comparable to that of navigating past a plurality of billboards disposed alongside a highway, wherein the plurality of billboards and the highway represent the at least two panel views and the common time axis, respectively.

### DETAILED DESCRIPTION

Conventional data visualization schemes depict time series data in a two-dimensional chart, with the horizontal axis usually representing time, and the vertical axis depicting the event and a value associated with the event (i.e., stock price or CPU usage). In these schemes, data events that occur concurrently are stacked or overlaid on top of each other. Another common method for presenting time series data involves using a table, with rows showing the chronological order and columns showing the events and any associated attributes. Other representations may include sequence diagrams which are helpful for depicting sequences of events but provide no temporal relationships between the events.

Conventional user interfaces used in network surveillance and monitoring systems utilize tiles that may be layered across evenly spaced rows on a 2D plane. One distinguishing feature provided in some embodiments of the present technology is that network events are represented as timed event cards or panels similar to billboards observed when driving on a road. The event cards or panels provide a 3D perspective with the z-axis representing the time traversed to reach the next card or panel representing the next event. The cards are thus not evenly spaced but placed according to the distance in time on the z-axis. Also, some embodiments of the present technology illustrate the relationship between network events and the corresponding chronological order on the same plane, thus providing an intuitive approach for navigating network events.

Some embodiments of the present technology enable a user to navigate through time series of event occurrences in a form that may be analogous to driving along a “road” with billboard cards representing event occurrences, and the landscape and weather elements depicting the context of the event. Each billboard card may include text and graphical elements that may describe the attributes of the event. The user may go forward and backward through the road of time to examine the billboards. The billboards are spaced apart according to their time of occurrence. This may be analogous to the way time is represented along the z-axis (3rd dimension) in accordance with some embodiments of the present technology. This visual rendering format allows concurrent events to be space out on the two-dimensional display. In this way, the relationship between concurrent events, such as transmission by a sender and receipt by a receiver, may be depicted together with the chronological properties. The sender and receiver may not be the direct chronological successor.

Some of the capabilities provided by the embodiments of the present technology include:
a. Visualizing of events, such as audit log entries, along a visually implemented time axis.
b. Identification of associations and causal relationships (i.e., cause-effect) among events.
c. Visualization of data flow across the events in the system (i.e., network device discovered and provisioned).
d. Rapid identification of a fault condition root cause, for example, detecting a race condition or a deadlock to access a shared resource.
e. Ability to monitor a continuous stream of network events in real time
f. Rendering the solution on small (e.g. phone, tablet) and big screen sizes.

In accordance with some embodiments of the present technology, each (network) event at a particular point in time may be represented in a form of a card or panel. The card may have textual description of an event or workflow and a thumbnail image which identifies the workflow. The cards may have color-coded tags which show if the result of workflow was success, failure or warning. A user may interact with the card by clicking on it to get detailed information about the event and the results associated with it. The user may also navigate using a slider or scroll bar which would allow them to bi-directionally traverse a time axis (i.e., going forward or backward in time) and view the event cards or panel views along the z-axis (3rd dimension) of the perspective. The user may search and filter the panel views/event cards (corresponding to various network events) based on a specified filtering criteria (i.e., attributes such as IP ranges, device identifiers, users and workflows). In this way, a subset of panel views that match the specified filtering criteria may be displayed along the time axis representation. The user may also search based on tags, such that only the failed events could be filtered for troubleshooting.

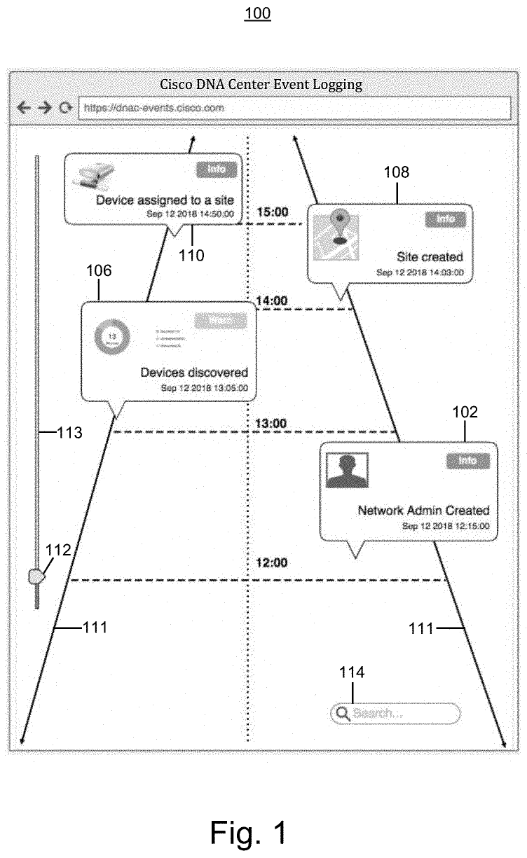

As an example is illustrated in FIG. 1 to further clarify the described functionalities associated with some embodiments of the present technology. FIG. 1 illustrates an example interface view 100 that provides a visual rendering of a set of network events triggered as a result of a common workflow initiated by, for example, a Cisco DNA Center™ administrator. With reference to FIG. 1, at 102 Network Administrator profile is created. The network administrator then initiates a device discovery operation shown by the panel view 106. A site is then created by the network administrator, corresponding to the panel view 108 and one or more devices are assigned to the created site as indicated by 110. As shown by the interface view 100, the workflow information is visually represented as a series of events (102, 106, 108 and 110) along a time axis 111. The interface view 100 also provides a slider 112 as a navigation mechanism responsive to user input. The slider 112 enables a user to navigate further through the timeline by sliding the slider 112 along a scroll bar 113. Furthermore, the search box 114 shown in the example interface view 100, enables the network monitoring system to conduct a search based on one or more user-provided filtering criteria (i.e., on one or more IP addresses) such that only events related to the specified criteria will appear.

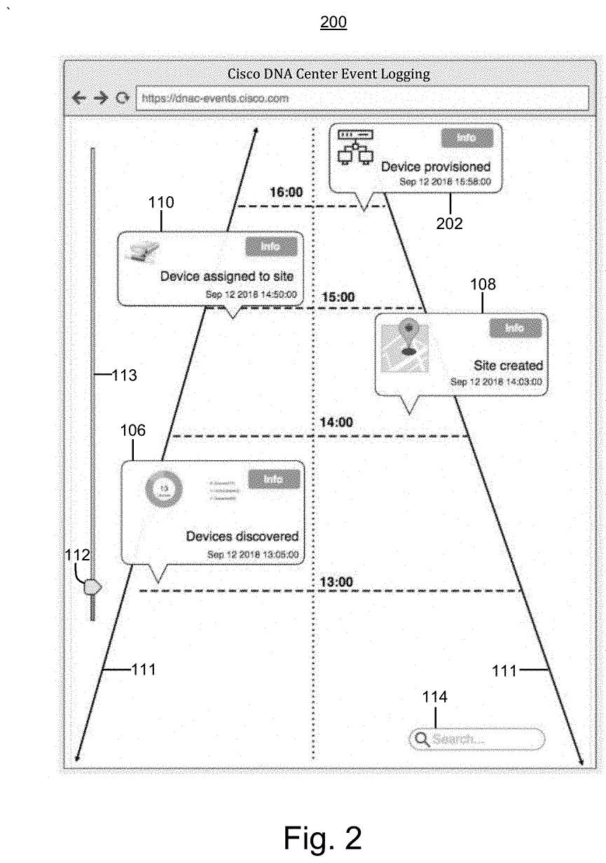

With reference to interface view 100, the chronological progression of the workflow is represented visually in an immediately identifiable way, starting from a user profile creation event at 12:15 hrs and includes subsequent events, triggered by the administrator initiated workflow, that occur within a 3 hour time period from 12:00 pm to 3:00 pm (15:00 hrs) as shown by the referenced points along the time axis 111. FIG. 2 illustrates an interface view 200 corresponding to moving the slider 112 to a position along the scroll bar 113 corresponding to 13:00 Hrs on the time axis 111. With respect to the interface view 200, the slider position corresponds to Device Discovery event at 13:05 Hrs. Considering that the displayed portion of the time axis 111, in the provided example, corresponds to a 3 hour time period, this brings into view event panel 204 corresponding to a device provisioning operation conducted as part of the network administrator's workflow.

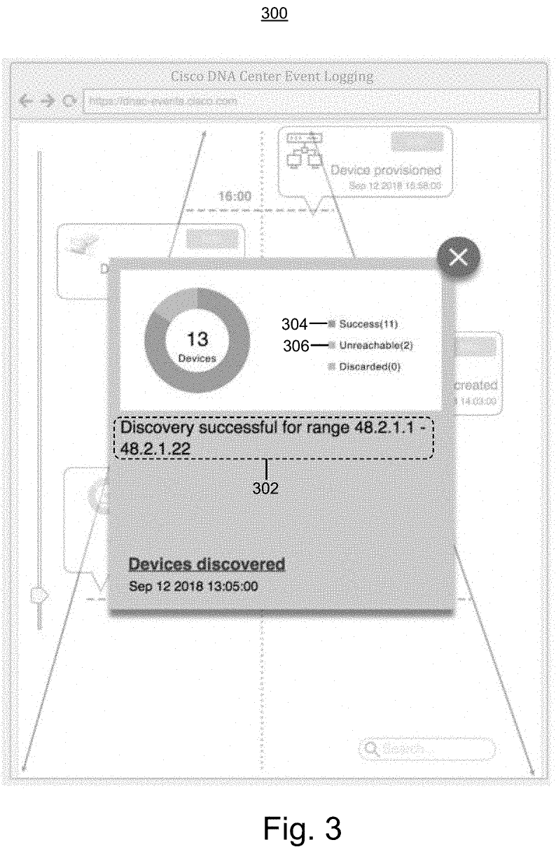

The panel view corresponding to various network-related events are interactive and in response to user input (i.e., a mouse click) may provide additional information with regards to the corresponding network-related event. For example, Interface view 300 provided in FIG. 3 corresponds to the monitoring system response based on receiving a user input directed to the event panel 106 corresponding to a device discovery event. The interface view 300, shown in FIG. 3, provides details about the corresponding network event which may include additional inputs provided by the administrator as part of the workflow and its results. For instance, it may be deduced from the example interface view 300, that the input request from the administrator was to run the discovery for IP Range 48.2.1.1 to 48.2.1.22 (302). As a result of which, 11 devices were discovered (304) and 2 devices were unreachable (306). In a similar way, a network admin may view all of these events in an intuitive way and can obtain the required information very quickly.

In some embodiments of the present technology, backend implementation may allow recording of concurrent events in multi-node environments as multiple streams. The network monitoring system and user interface, as provided by some embodiments of the present technology, enable a visual rendering of multiple network event streams, including concurrent ones.

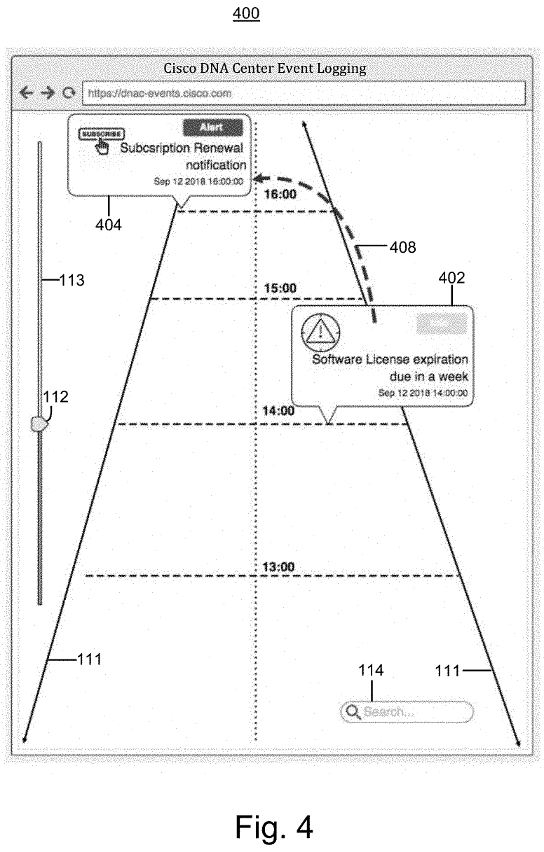

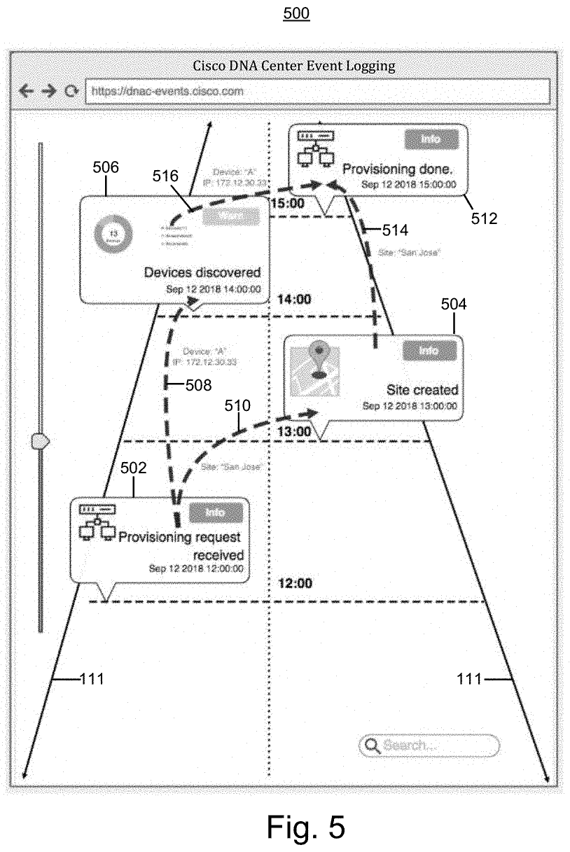

A network monitoring system featuring a user interface, as described in accordance to some embodiments of the present technology, may provide a more meaningful representation of inter-related or correlated network events, by adding a time perspective to the representation. Such a network monitoring interface enables a more effective depiction of events with a causal (i.e., cause-effect) relationships, and may significantly simplify retracing of the steps that may have occurred over time under a common workflow. This functionality is represented by example interface views 400 and 500 provided in FIGS. 4 and 5, respectively.

Turning now to the example interface view 400 in FIG. 4, a network alert corresponding to an approaching “Software License subscription expiration date” is represented by panel view 402 disposed at the 14:00 hrs (2:00 pm) point along the time axis 111. A causal link or relationship may then be in established between this network event corresponding to panel view 402 and a network event corresponding to a subscription Renewal notification represented by panel view 404 disposed at the 16:00 hrs point along the time axis 111. As such the network event at 14:00 hrs represented by panel view 402 may be immediately established as the cause and the network event at 16:00 hrs represented by panel view 404 as the effect. The dotted line 408 between these two events convey the cause-effect relationship.

Some embodiments of the present technology provide an effective method of illustrating data flow between entities or events along with a time perspective. An example may involve a data flow associated with a request submitted by a user for provisioning a device to a particular site. In such a scenario, various components of a network system may serve these requests and pass along the processed data to each other. A visual representation of data flow and events corresponding to the above example may be provided, in accordance with some embodiments of the present technology, with reference to the example interface view 500 illustrated in FIG. 5.

Turning now to FIG. 5, a request event for provisioning of a device (i.e. device A) to a particular site (i.e., site B), is submitted by a user at 12:00 pm. This event is represented by panel view 502 disposed at the 12:00 hrs point along the time axis 111. Site “B” is created successfully at time 13:00 hrs, using the data received from an event at time 12:00 hrs. This event is represented by panel view 504 disposed at the 13:00 hrs point along the time axis 111. Device “A” is added to the existing inventory at time 14:00 hrs using the data received from an event at time 12:00 hrs. This event is represented by panel view 506 disposed at the 14:00 hrs point along the time axis 111. For illustration purposes, in the example interface view 500 the aforementioned data flow is depicted using directed arrows 508 and 510. Referring back to FIG. 5, the provisioning of Device “A” to the site “B” is completed at time 15:00 hrs, using the data received from events at time 13:00 hrs and 14:00 hrs. This event is represented by panel view 512 disposed at the 15:00 hrs point along the time axis 111 and the associated data flow is depicted using directed arrows 514 and 516.

Note that, for illustration purposes, in the example interface view representations 400 and 500 in FIGS. 4 and 5, the data flow is depicted using a directed arrow and the actual data passed along is also displayed as a label. The message flow between services may be used to depict the data flow discussed above.

Embodiments of the present technology further facilitate and simplify the identification of root causes associated with network issues/defects in the system, as network events are depicted as a chain of events occurring over time along with all the associated contextual data. Accordingly, the task of identifying operational constraint such as multiple events simultaneously initiating access to a same network resource (i.e., resource contention or deadlock situation) is made simpler and more straightforward by embodiments of the present technology. For example, it would be easy to find out which events are trying to access the same resource at the same time, thus possibly triggering a resource contention or a deadlock event.

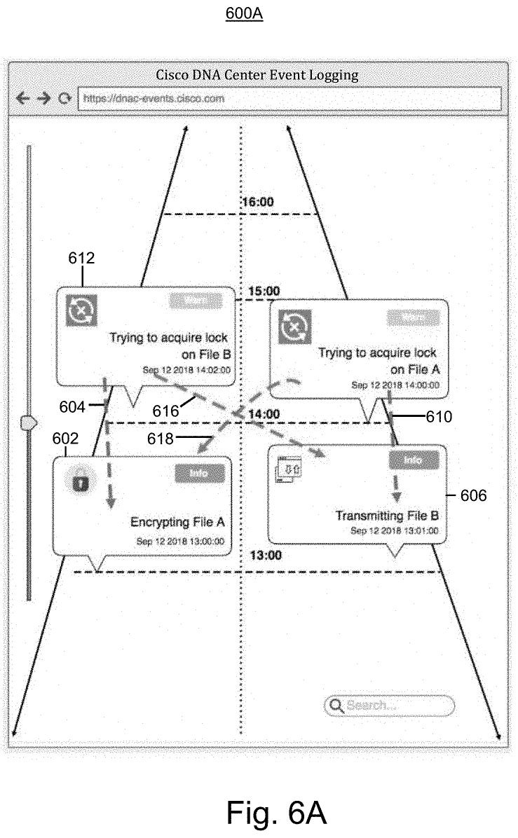

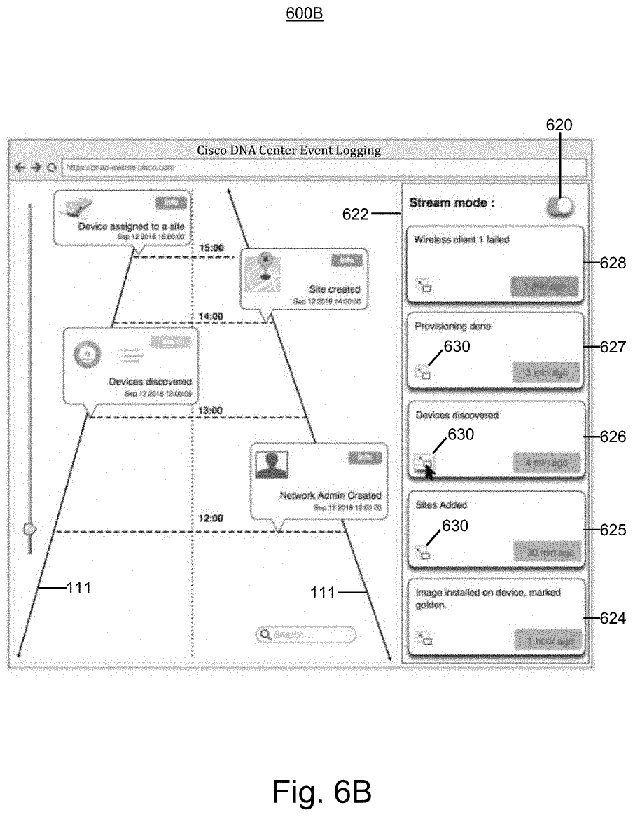

Providing a time perspective when visually representing inter-related/inter-dependent events, as described by some embodiments of the present technology, facilitates an easy and immediate recognition of relationships and/or dependencies that may exist among various network events. This may be further clarified by a depiction of a deadlock scenario provided in the example interface view 600A in FIG. 6A.

An example scenario involving the execution of two different workflows in the system is provided by the interface view 600A in FIG. 6A. With reference to the interface view 600A, the first workflow corresponds to the encrypting of file A (represented by panel view 602) to be followed by the encrypting of file B. The order is shown in FIG. 6A using a directed arrow 604. The second workflow corresponds to the transmitting of file B (represented by panel view 606) to be followed by the transmitting of file A upon completion of file B transmission. The order is shown in FIG. 6A using a directed arrow 610.

With reference to FIG. 6A, note that the event “Trying to acquire lock on File B” (represented by the panel view 612 disposed at a point along time axis corresponding to 14:02 hrs) is waiting for an event “Transmitting File B” (represented by the panel view 606 disposed at a point along time axis corresponding to 13:01 hrs) to finish and release the lock on file B. Similarly, the event “Trying to acquire lock on File A” (represented by the panel view 614 at the 14:00 hrs point along the time axis) is waiting for an event “Encrypting File A” (represented by the panel view 610 disposed at a point along time axis corresponding to 13:00 hrs) to finish and release the lock on file A. The aforementioned two scenarios may create a deadlock situation. The deadlock scenario is depicted using directed arrows 616 and 618 in FIG. 6A. In accordance with some embodiments, tools that detect deadlocks using the heap dumps may be used for providing the necessary to a user interface of a network monitoring system.

In accordance with some embodiments of the present technology, a network monitoring system may live stream network events or fault condition to the user Interface in such a way so as to enable a user to continuously monitor the current state of the network. An example of the aforementioned functionality may be provided with reference to the interface view 600B in FIG. 6B.

Turning now to the example interface view 600B in FIG. 6B, a network monitoring system, upon receiving user input to turn ON the switch 620, may enable streaming mode by opening a web socket and allowing network events to be shown on the side panel 622 as they occur in real time. With respect to the example interface view 600B shown in FIG. 6B network events being displayed inside panel 622 in real time are represented by panel views 624-628. An interface control service may direct a user to an event panel disposed along the time axis 111 when it receives a user input (i.e., a mouse clicks) directed at the “pop-out” control 630 disposed in the panel view (along the side panel 622) associated to that particular event. According to some embodiments, a web socket that would allow the user interface to receive the stream data and showcase the on-going events may be used to make this rendering possible.

Some embodiments of the present technology allow users to: Visualize, and navigate the events in the system in an easily understandable format; Use contextual data and time perspective to correlate events and use the same for troubleshooting network performance issues; Utilize the color-coded tags (info/warning) and a search box to filter the event views, and to continuously monitor issues or events in real time.

Some embodiments of the present technology provide a novel user interface framework that delivers functionality directed to intuitive displaying of event data across small and large display sizes which furthermore enables features such as operational constraint conditions (i.e., deadlock conditions, throughput bottleneck conditions, operational dependency conditions), cause-effect relationships, data flow, event attributes and chronological ordering to be displayed in the same view. Additionally, by providing a visual rendering of the “distance in time” between events, the disclosed network monitoring system and user interface enable race conditions, deadlocks and concurrencies to be depicted in an intuitive fashion.

In accordance with some embodiments, the present technology may be implemented in the context of a Cisco's Digital Network Architecture Center (Cisco DNA Center™) which is a foundational controller and analytics platform for an intent-based enterprise network.

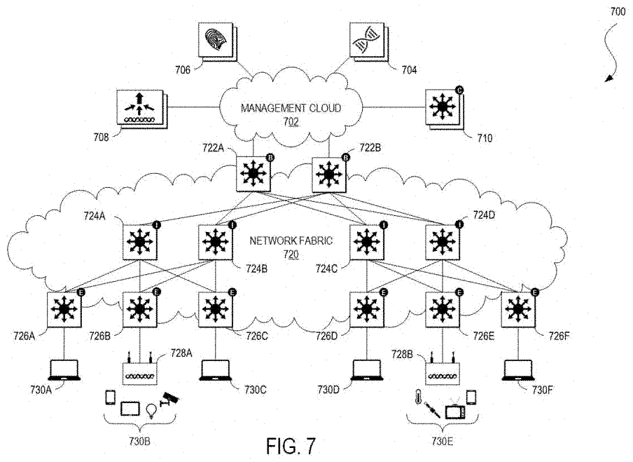

The disclosure now turns to FIGS. 7, 8 and 9 to provide a structural and operational description of some aspects of Cisco DNA Center™.

FIG. 7 illustrates an example of a physical topology of an enterprise network 700 for providing intent-based networking. It should be understood that, for the enterprise network 700 and any network discussed herein, there can be additional or fewer nodes, devices, links, networks, or components in similar or alternative configurations. Example embodiments with different numbers and/or types of endpoints, nodes, cloud components, servers, software components, devices, virtual or physical resources, configurations, topologies, services, appliances, or deployments are also contemplated herein. Further, the enterprise network 700 can include any number or type of resources, which can be accessed and utilized by endpoints or network devices. The illustrations and examples provided herein are for clarity and simplicity.

In this example, the enterprise network 700 includes a management cloud 702 and a network fabric 720. Although shown as an external network or cloud to the network fabric 720 in this example, the management cloud 702 may alternatively or additionally reside on the premises of an organization or in a colocation center (in addition to being hosted by a cloud provider or similar environment). The management cloud 702 can provide a central management plane for building and operating the network fabric 720. The management cloud 702 can be responsible for forwarding configuration and policy distribution, as well as device management and analytics. The management cloud 702 can comprise one or more network controller appliances 704, one or more authentication, authorization, and accounting (AAA) appliances 706, one or more wireless local area network controllers (WLCs) 708, and one or more fabric control plane nodes 710. In other embodiments, one or more elements of the management cloud 702 may be co-located with the network fabric 720.

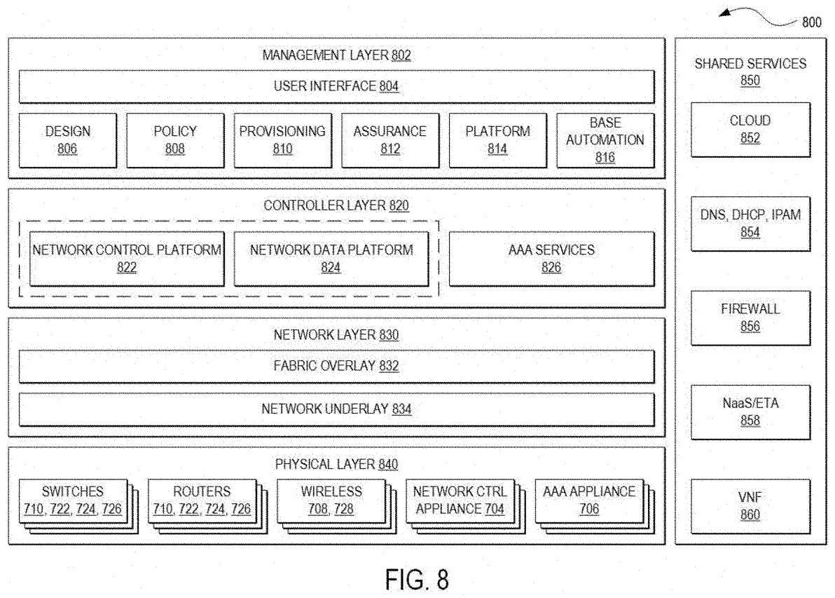

The network controller appliance(s) 704 can function as the command and control system for one or more network fabrics and can house automated workflows for deploying and managing the network fabric(s). The network controller appliance(s) 704 can include automation, design, policy, provisioning, and assurance capabilities, among others, as discussed further below with respect to FIG. 8. In some embodiments, one or more Cisco Digital Network Architecture Center (Cisco DNA Center™) appliances can operate as the network controller appliance(s) 704.

The AAA appliance(s) 706 can control access to computing resources, facilitate enforcement of network policies, audit usage, and provide information necessary to bill for services. The AAA appliance can interact with the network controller appliance(s) 704 and with databases and directories containing information for users, devices, things, policies, billing, and similar information to provide authentication, authorization, and accounting services. In some embodiments, the AAA appliance(s) 706 can utilize Remote Authentication Dial-In User Service (RADIUS) or Diameter to communicate with devices and applications. In some embodiments, one or more Cisco® Identity Services Engine (ISE) appliances can operate as the AAA appliance(s) 706.

The WLC(s) 708 can support fabric-enabled access points attached to the network fabric 720, handling traditional tasks associated with a WLC as well as interactions with the fabric control plane for wireless endpoint registration and roaming. In some embodiments, the network fabric 720 can implement a wireless deployment that moves data-plane termination (e.g., VXLAN) from a centralized location (e.g., with previous overlay Control and Provisioning of Wireless Access Points (CAPWAP) deployments) to an access point/fabric edge node. This can enable distributed forwarding and distributed policy application for wireless traffic while retaining the benefits of centralized provisioning and administration. In some embodiments, one or more Cisco® Wireless Controllers, Cisco® Wireless LAN, and/or other Cisco DNA Center™ ready wireless controllers can operate as the WLC(s) 708.

The network fabric 720 can comprise fabric border nodes 722A and 722B (collectively, 722), fabric intermediate nodes 724A-D (collectively, 724), and fabric edge nodes 726A-F (collectively, 726). Although the fabric control plane node(s) 710 are shown to be external to the network fabric 720 in this example, in other embodiments, the fabric control plane node(s) 710 may be co-located with the network fabric 720. In embodiments where the fabric control plane node(s) 710 are co-located with the network fabric 720, the fabric control plane node(s) 710 may comprise a dedicated node or set of nodes or the functionality of the fabric control node(s) 710 may be implemented by the fabric border nodes 722.

The fabric control plane node(s) 710 can serve as a central database for tracking all users, devices, and things as they attach to the network fabric 720, and as they roam around. The fabric control plane node(s) 710 can allow network infrastructure (e.g., switches, routers, WLCs, etc.) to query the database to determine the locations of users, devices, and things attached to the fabric instead of using a flooding mechanism. In this manner, the fabric control plane node(s) 710 can operate as a single source of truth about where every endpoint attached to the network fabric 720 is located at any point in time. In addition to tracking specific endpoints (e.g., /32 address for IPv4, /728 address for IPv6, etc.), the fabric control plane node(s) 710 can also track larger summarized routers (e.g., IP/mask). This flexibility can help in summarization across fabric sites and improve overall scalability.

The fabric border nodes 722 can connect the network fabric 720 to traditional Layer 3 networks (e.g., non-fabric networks) or to different fabric sites. The fabric border nodes 722 can also translate context (e.g., user, device, or thing mapping and identity) from one fabric site to another fabric site or to a traditional network. When the encapsulation is the same across different fabric sites, the translation of fabric context is generally mapped 1:1. The fabric border nodes 722 can also exchange reachability and policy information with fabric control plane nodes of different fabric sites. The fabric border nodes 722 also provide border functions for internal networks and external networks. Internal borders can advertise a defined set of known subnets, such as those leading to a group of branch sites or to a data center. External borders, on the other hand, can advertise unknown destinations (e.g., to the Internet similar in operation to the function of a default route).

The fabric intermediate nodes 724 can operate as pure Layer 3 forwarders that connect the fabric border nodes 722 to the fabric edge nodes 726 and provide the Layer 3 underlay for fabric overlay traffic.

The fabric edge nodes 726 can connect endpoints to the network fabric 720 and can encapsulate/de-capsulate and forward traffic from these endpoints to and from the network fabric. The fabric edge nodes 726 may operate at the perimeter of the network fabric 720 and can be the first points for the attachment of users, devices, and things and the implementation of policy. In some embodiments, the network fabric 720 can also include fabric extended nodes (not shown) for attaching downstream non-fabric Layer 2 network devices to the network fabric 720 and thereby extend the network fabric. For example, extended nodes can be small switches (e.g., compact switch, industrial Ethernet switch, building automation switch, etc.) which connect to the fabric edge nodes via Layer 2. Devices or things connected to the fabric extended nodes can use the fabric edge nodes 726 for communication to outside subnets.

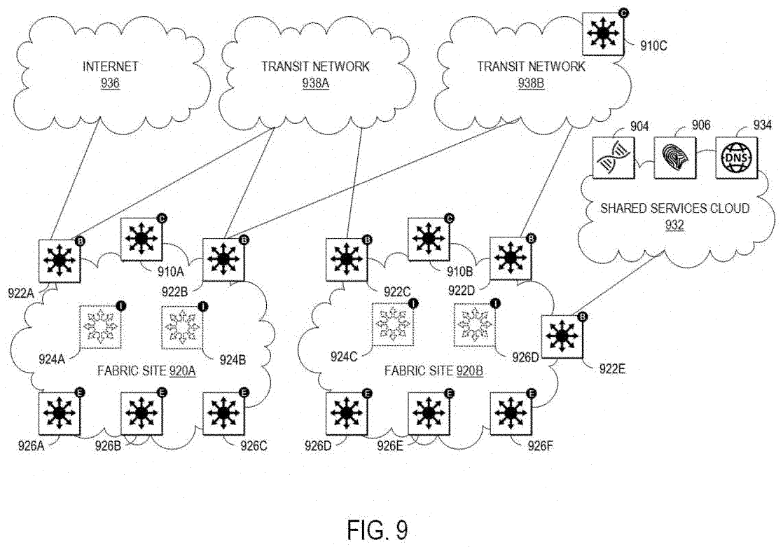

In this example, the network fabric can represent a single fabric site deployment which can be differentiated from a multi-site fabric deployment as discussed further below with respect to FIG. 9.

In some embodiments, all subnets hosted in a fabric site can be provisioned across every fabric edge node 726 in that fabric site. For example, if the subnet 10.10.10.0/24 is provisioned in a given fabric site, this subnet may be defined across all of the fabric edge nodes 726 in that fabric site, and endpoints located in that subnet can be placed on any fabric edge node 726 in that fabric. This can simplify IP address management and allow deployment of fewer but larger subnets. In some embodiments, one or more Cisco® Catalyst switches, Cisco Nexus® switches, Cisco Meraki® MS switches, Cisco® Integrated Services Routers (ISRs), Cisco® Aggregation Services Routers (ASRs), Cisco® Enterprise Network Compute Systems (ENCS), Cisco® Cloud Service Virtual Routers (CSRvs), Cisco Integrated Services Virtual Routers (ISRvs), Cisco Meraki® MX appliances, and/or other Cisco DNA Center™ ready devices can operate as the fabric nodes 722, 724, and 726.

The enterprise network 700 can also include wired endpoints 730A, 730C, 730D, and 730F and wireless endpoints 730B and 730E (collectively, 730). The wired endpoints 730A, 730C, 730D, and 730F can connect by wire to fabric edge nodes 726A, 726C, 726D, and 726F, respectively, and the wireless endpoints 730B and 730E can connect wirelessly to wireless access points 728B and 728E (collectively, 728), respectively, which in turn can connect by wire to fabric edge nodes 726B and 726E, respectively. In some embodiments, Cisco Aironet® access points, Cisco Meraki® MR access points, and/or other Cisco DNA Center™ ready access points can operate as the wireless access points 728.

The endpoints 730 can include general purpose computing devices (e.g., servers, workstations, desktop computers, etc.), mobile computing devices (e.g., laptops, tablets, mobile phones, etc.), wearable devices (e.g., watches, glasses or other head-mounted displays (HMDs), ear devices, etc.), and so forth. The endpoints 730 can also include Internet of Things (IoT) devices or equipment, such as agricultural equipment (e.g., livestock tracking and management systems, watering devices, unmanned aerial vehicles (UAVs), etc.); connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc.); retail equipment (e.g., vending machines, point of sale (POS) devices, Radio Frequency Identification (RFID) tags, etc.); smart city devices (e.g., street lamps, parking meters, waste management sensors, etc.); transportation and logistical equipment (e.g., turnstiles, rental car trackers, navigational devices, inventory monitors, etc.); and so forth.

In some embodiments, the network fabric 720 can support wired and wireless access as part of a single integrated infrastructure such that connectivity, mobility, and policy enforcement behavior are similar or the same for both wired and wireless endpoints. This can bring a unified experience for users, devices, and things that are independent of the access media.

In integrated wired and wireless deployments, control plane integration can be achieved with the WLC(s) 708 notifying the fabric control plane node(s) 710 of joins, roams, and disconnects by the wireless endpoints 730 such that the fabric control plane node(s) can have connectivity information about both wired and wireless endpoints in the network fabric 720, and can serve as the single source of truth for endpoints connected to the network fabric. For data plane integration, the WLC(s) 708 can instruct the fabric wireless access points 728 to form a VXLAN overlay tunnel to their adjacent fabric edge nodes 726. The AP VXLAN tunnel can carry segmentation and policy information to and from the fabric edge nodes 726, allowing connectivity and functionality identical or similar to that of a wired endpoint. When the wireless endpoints 730 join the network fabric 720 via the fabric wireless access points 728, the WLC(s) 708 can onboard the endpoints into the network fabric 720 and inform the fabric control plane node(s) 710 of the endpoints' Media Access Control (MAC) addresses. The WLC(s) 708 can then instruct the fabric wireless access points 728 to form VXLAN overlay tunnels to the adjacent fabric edge nodes 726. Next, the wireless endpoints 730 can obtain IP addresses for themselves via Dynamic Host Configuration Protocol (DHCP). Once that completes, the fabric edge nodes 726 can register the IP addresses of the wireless endpoint 730 to the fabric control plane node(s) 710 to form a mapping between the endpoints' MAC and IP addresses, and traffic to and from the wireless endpoints 730 can begin to flow.

FIG. 8 illustrates an example of a logical architecture 800 for an enterprise network (e.g., the enterprise network 700). One of ordinary skill in the art will understand that, for the logical architecture 800 and any system discussed in the present disclosure, there can be additional or fewer components in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure. In this example, the logical architecture 800 includes a management layer 802, a controller layer 820, a network layer 830 (such as embodied by the network fabric 720), a physical layer 840 (such as embodied by the various elements of FIG. 7), and a shared services layer 850.

The management layer 802 can abstract the complexities and dependencies of other layers and provide a user with tools and workflows to manage an enterprise network (e.g., the enterprise network 700). The management layer 802 can include a user interface 804, design functions 806, policy functions 808, provisioning functions 810, assurance functions 812, platform functions 814, and base automation functions 816. The user interface 804 can provide a user with a single point to manage and automate the network. The user interface 804 can be implemented within a web application/web server accessible by a web browser and/or an application/application server accessible by a desktop application, a mobile app, a shell program or other command line interface (CLI), an Application Programming Interface (e.g., restful state transfer (REST), Simple Object Access Protocol (SOAP), Service Oriented Architecture (SOA), etc.), and/or another suitable interface in which the user can configure network infrastructure, devices, and things that are cloud-managed; provide user preferences; specify policies, enter data; review statistics; configure interactions or operations; and so forth. The user interface 804 may also provide visibility information, such as views of a network, network infrastructure, computing devices, and things. For example, the user interface 804 can provide a view of the status or conditions of the network, the operations taking place, services, performance, topology or layout, protocols implemented, running processes, errors, notifications, alerts, network structure, ongoing communications, data analysis, and so forth.

The design functions 806 can include tools and workflows for managing site profiles, maps, and floor plans, network settings, and IP address management, among others. The policy functions 808 can include tools and workflows for defining and managing network policies. The provisioning functions 810 can include tools and workflows for deploying the network. The assurance functions 812 can use machine learning and analytics to provide end-to-end visibility of the network by learning from the network infrastructure, endpoints, and other contextual sources of information. The platform functions 814 can include tools and workflows for integrating the network management system with other technologies. The base automation functions 816 can include tools and workflows to support the policy functions 808, the provisioning functions 810, the assurance functions 812, and the platform functions 814.

In some embodiments, the design functions 806, the policy functions 808, the provisioning functions 810, the assurance functions 812, the platform functions 814, and the base automation functions 816 can be implemented as microservices in which respective software functions are implemented in multiple containers communicating with each rather than amalgamating all tools and workflows into a single software binary. Each of the design functions 806, policy functions 808, provisioning functions 810, assurance functions 812, and platform functions 814 can be viewed as a set of related automation microservices to cover the design, policy authoring, provisioning, assurance, and cross-platform integration phases of the network lifecycle. The base automation functions 814 can support the top-level functions by allowing users to perform certain network-wide tasks.

Returning to FIG. 8, the controller layer 820 can comprise subsystems for the management layer 820 and may include a network control platform 822, a network data platform 824, and AAA services 826. These controller subsystems can form an abstraction layer to hide the complexities and dependencies of managing many network elements and protocols.

The network control platform 822 can provide automation and orchestration services for the network layer 830 and the physical layer 840, and can include the settings, protocols, and tables to automate management of the network and physical layers. For example, the network control platform 830 can provide the design functions 806, the provisioning functions 808 812. In addition, the network control platform 830 can include tools and workflows for discovering switches, routers, wireless controllers, and other network infrastructure devices (e.g., the network discovery tool); maintaining network and endpoint details, configurations, and software versions (e.g., the inventory management tool); Plug-and-Play (PnP) for automating deployment of network infrastructure (e.g., the network PnP tool), Path Trace for creating visual data paths to accelerate the troubleshooting of connectivity problems, Easy QoS for automating quality of service to prioritize applications across the network, and Enterprise Service Automation (ESA) for automating deployment of physical and virtual network services, among others. The network control platform 822 can communicate with network elements using Network Configuration (NETCONF)/Yet Another Next Generation (YANG), Simple Network Management Protocol (SNMP), Secure Shell (SSH)/Telnet, and so forth. In some embodiments, the Cisco® Network Control Platform (NCP) can operate as the network control platform 822

The network data platform 824 can provide for network data collection, analytics, and assurance, and may include the settings, protocols, and tables to monitor and analyze network infrastructure and endpoints connected to the network. The network data platform 824 can collect multiple types of information from network infrastructure devices, including Syslog, SNMP, NetFlow, Switched Port Analyzer (SPAN), and streaming telemetry, among others. The network data platform 824 can also collect use contextual information shared from

In some embodiments, one or more Cisco DNA Center™ appliances can provide the functionalities of the management layer 810, the network control platform 822, and the network data platform 824. The Cisco DNA Center™ appliances can support horizontal scalability by adding additional Cisco DNA Center™ nodes to an existing cluster; high availability for both hardware components and software packages; backup and store mechanisms to support disaster discovery scenarios; role-based access control mechanisms for differentiated access to users, devices, and things based on roles and scope; and programmable interfaces to enable integration with third-party vendors. The Cisco DNA Center™ appliances can also be cloud-tethered to provide for the upgrade of existing functions and additions of new packages and applications without having to manually download and install them.

The AAA services 826 can provide identity and policy services for the network layer 830 and physical layer 840, and may include the settings, protocols, and tables to support endpoint identification and policy enforcement services. The AAA services 826 can provide tools and workflows to manage virtual networks and security groups and to create group-based policies and contracts. The AAA services 826 can identify and profile network infrastructure devices and endpoints using AAA/RADIUS, 802.1X, MAC Authentication Bypass (MAB), web authentication, and EasyConnect, among others. The AAA services 826 can also collect and use contextual information from the network control platform 822, the network data platform 824, and the shared services 850, among others. In some embodiments, Cisco® ISE can provide the AAA services 826.

The network layer 830 can be conceptualized as a composition of two layers, an underlay 834 comprising physical and virtual network infrastructure (e.g., routers, switches, WLCs, etc.) and a Layer 3 routing protocol for forwarding traffic, and an overlay 832 comprising a virtual topology for logically connecting wired and wireless users, devices, and things and applying services and policies to these entities. Network elements of the underlay 834 can establish connectivity between each other, such as via Internet Protocol (IP). The underlay may use any topology and routing protocol.

In some embodiments, the network controller 704 can provide a local area network (LAN) automation service, such as implemented by Cisco DNA Center™ LAN Automation, to automatically discover, provision, and deploy network devices. Once discovered, the automated underlay provisioning service can leverage Plug and Play (PnP) to apply the required protocol and network address configurations to the physical network infrastructure. In some embodiments, the LAN automation service may implement the Intermediate System to Intermediate System (IS-IS) protocol. Some of the advantages of IS-IS include neighbor establishment without IP protocol dependencies, peering capability using loopback addresses, and agnostic treatment of IPv4, IPv6, and non-IP traffic.

The overlay 832 can be a logical, virtualized topology built on top of the physical underlay 834, and can include a fabric data plane, a fabric control plane, and a fabric policy plane. In some embodiments, the fabric data plane can be created via packet encapsulation using Virtual Extensible LAN (VXLAN) with Group Policy Option (GPO). Some of the advantages of VXLAN-GPO include its support for both Layer 2 and Layer 3 virtual topologies (overlays), and its ability to operate over any IP network with built-in network segmentation.

In some embodiments, the fabric control plane can implement Locator/ID Separation Protocol (LISP) for logically mapping and resolving users, devices, and things. LISP can simplify routing by removing the need for each router to process every possible IP destination address and route. LISP can achieve this by moving remote destination to a centralized map database that allows each router to manage only its local routs and query the map system to locate destination endpoints.

The fabric policy plane is where intent can be translated into network policy. That is, the policy plane is where the network operator can instantiate logical network policy based on services offered by the network fabric 720, such as security segmentation services, quality of service (QoS), capture/copy services, application visibility services, and so forth.

Segmentation is a method or technology used to separate specific groups of users or devices from other groups for the purpose of reducing congestion, improving security, containing network problems, controlling access, and so forth. As discussed, the fabric data plane can implement VXLAN encapsulation to provide network segmentation by using the virtual network identifier (VNI) and Scalable Group Tag (SGT) fields in packet headers. The network fabric 720 can support both macro-segmentation and micro-segmentation. Macro-segmentation logically separates a network topology into smaller virtual networks by using a unique network identifier and separate forwarding tables. This can be instantiated as a virtual routing and forwarding (VRF) instance and referred to as a virtual network (VN). That is, a VN is a logical network instance within the network fabric 720 defined by a Layer 3 routing domain and can provide both Layer 2 and Layer 3 services (using the VXLAN VNI to provide both Layer 2 and Layer 3 segmentation). Micro-segmentation logically separates user or device groups within a VN, by enforcing source to destination access control permissions, such as by using access control lists (ACLs). A scalable group is a logical object identifier assigned to a group of users, devices, or things in the network fabric 720. It can be used as source and destination classifiers in Scalable Group ACLs (SGACLs). The SGT can be used to provide address-agnostic group-based policies.

In some embodiments, the fabric control plane node 710 may implement the Locator/Identifier Separation Protocol (LISP) to communicate with one another and with the management cloud 702. Thus, the control plane nodes may operate a host tracking database, a map server, and a map resolver. The host tracking database can track the endpoints 730 connected to the network fabric 720 and associate the endpoints to the fabric edge nodes 726, thereby decoupling an endpoint's identifier (e.g., IP or MAC address) from its location (e.g., closest router) in the network.

The physical layer 840 can comprise network infrastructure devices, such as switches and routers 710, 722, 724, and 726 and wireless elements 708 and 728 and network appliances, such as the network controller appliance(s) 704, and the AAA appliance(s) 706.

The shared services layer 850 can provide an interface to external network services, such as cloud services 852; Domain Name System (DNS), DHCP, IP Address Management (IPAM), and other network address management services 854; firewall services 856; Network as a Sensor (Naas)/Encrypted Threat Analytics (ETA) services; and Virtual Network Functions (VNFs) 860; among others. The management layer 802 and/or the controller layer 820 can share identity, policy, forwarding information, and so forth via the shared services layer 850 using APIs.

FIG. 9 illustrates an example of a physical topology for a multi-site enterprise network 900. In this example, the network fabric comprises fabric sites 920A and 920B. The fabric site 920A can include a fabric control node 910A, fabric border nodes 922A and 922B, fabric intermediate nodes 924A and 924B (shown here in dashed line and not connected to the fabric border nodes or the fabric edge nodes for simplicity), and fabric edge nodes 926A-D. The fabric site 920B can include a fabric control node 910B, fabric border nodes 922C-E, fabric intermediate nodes 924C and 924D, and fabric edge nodes 926D-F. Multiple fabric sites corresponding to a single fabric, such as the network fabric of FIG. 9, can be interconnected by a transit network. A transit network can be a portion of a network fabric that has its own control plane nodes and border nodes but does not have edge nodes. In addition, a transit network shares at least one border node with each fabric site that it interconnects.

In general, a transit network connects a network fabric to the external world. There are several approaches to external connectivity, such as a traditional IP network 936, traditional WAN 938A, Software-Defined WAN (SD-WAN) (not shown), or Software-Defined Access (SD-Access) 938B. Traffic across fabric sites, and to other types of sites, can use the control plane and data plane of the transit network to provide connectivity between these sites. A local border node can operate as the handoff point from the fabric site, and the transit network can deliver traffic to other sites. The transit network may use additional features. For example, if the transit network is a WAN, then features like performance routing may also be used. To provide end-to-end policy and segmentation, the transit network should be cable of carrying endpoint context information (e.g., VRF, SGT) across the network. Otherwise, a re-classification of the traffic may be needed at the destination site border.

The local control plane in a fabric site may only hold state relevant to endpoints that are connected to edge nodes within the local fabric site. The local control plane can register local endpoints via local edge nodes, as with a single fabric site (e.g., the network fabric 720). An endpoint that isn't explicitly registered with the local control plane may be assumed to be reachable via border nodes connected to the transit network. In some embodiments, the local control plane may not hold state for endpoints attached to other fabric sites such that the border nodes do not register information from the transit network. In this manner, the local control plane can be independent of other fabric sites, thus enhancing the overall scalability of the network.

The control plane in the transit network can hold summary state for all fabric sites that it interconnects. This information can be registered to the transit control plane by a border from different fabric sites. The border nodes can register EID information from the local fabric site into the transit network control plane for summary EIDs only and thus further improve scalability.

The multi-site enterprise network 900 can also include a shared services cloud 932. The shared services cloud 932 can comprise one or more network controller appliances 904, one or more AAA appliances 906, and other shared servers (e.g., DNS; DHCP; IPAM; SNMP and other monitoring tools; NetFlow, Syslog, and other data collectors, etc.) may reside. These shared services can generally reside outside of the network fabric and in a global routing table (GRT) of an existing network. In this case, some method of inter-VRF routing may be required. One option for inter-VRF routing is to use a fusion router, which can be an external router that performs inter-VRF leaking (e.g., import/export of VRF routes) to fuse the VRFs together. Multi-Protocol can be used for this route exchange since it can inherently prevent routing loops (e.g., using the AS_PATH attribute). Other routing protocols can also be used but may require complex distribute-lists and prefix-lists to prevent loops.

However, there can be several disadvantages in using a fusion router to achieve inter-VN communication, such as route duplication because routes leaked from one VRF to another are programmed in hardware tables and can result in more TCAM utilization, manual configuration at multiple touch points wherever route-leaking is implemented, loss of SGT context because SGTs may not be maintained across VRFs and must be re-classified once the traffic enters the other VRF, and traffic hairpinning because traffic may need to be routed to the fusion router, and then back to the fabric border node.

SD-Access Extranet can provide a flexible and scalable method for achieving inter-VN communications by avoiding route duplication because inter-VN lookup occurs in the fabric control plane (e.g., software) such that route entries do not need to be duplicated in hardware; providing a single touchpoint because the network management system (e.g., Cisco DNA Center™) can automate the inter-VN lookup policy, making it a single point of management; maintaining SGT context because the inter-VN lookup occurs in the control plane node(s) (e.g., software), and avoids hair-pinning because inter-VN forwarding can occur at the fabric edge (e.g., the same intra-VN) so traffic does not need to hairpin at the border node. Another advantage is that a separate VN can be made for each of the common resources that are needed (e.g., a Shared Services VN, an Internet VN, a data center VN, etc.).

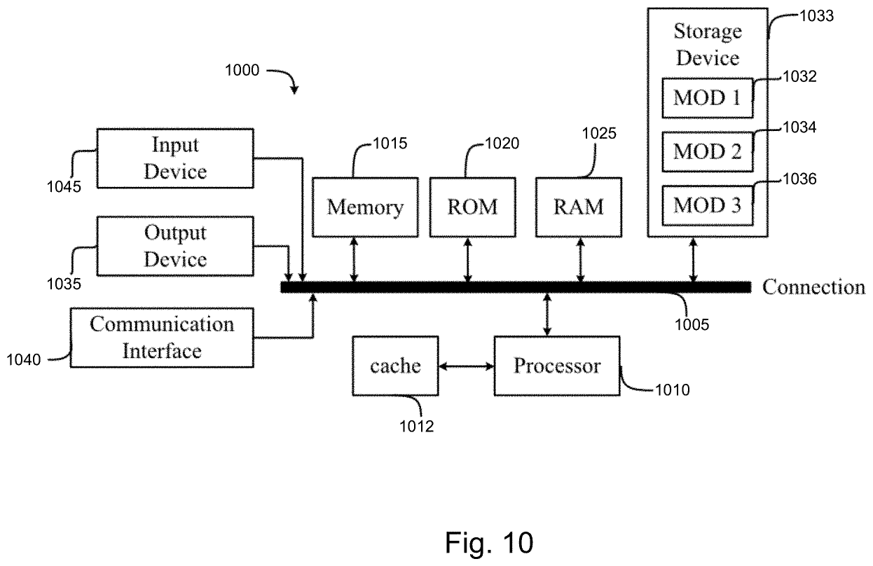

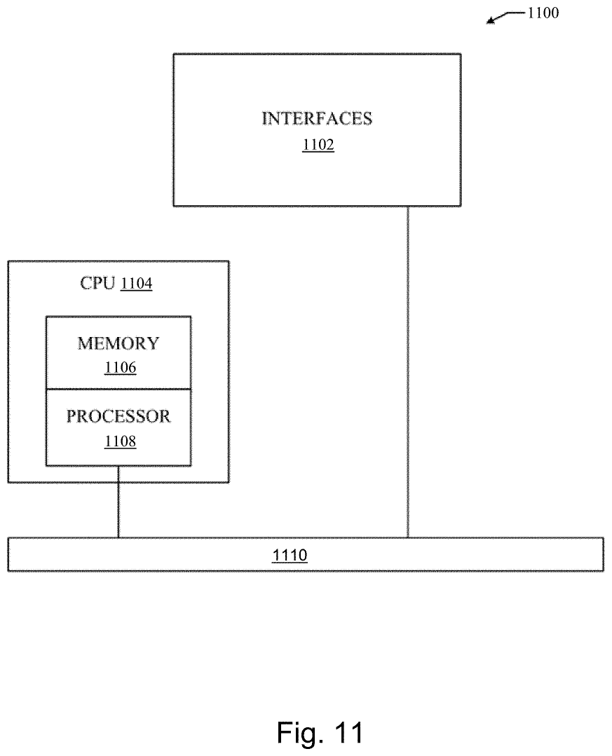

The disclosure now turns to FIGS. 10 and 11, which illustrate example architectures of computing and network devices, such as client computers, switches, routers, controllers, servers, and so forth.

FIG. 10 illustrates a computing system architecture 1000 including components in electrical communication with each other using a connection 1005, such as a bus. System 1000 includes a processing unit (CPU or processor) 1010 and a system connection 1005 that couples various system components including the system memory 1015, such as read-only memory (ROM) 1020 and random access memory (RAM) 1025, to the processor 1010. The system 1000 can include a cache of high-speed memory connected directly with, in close proximity to, or integrated as part of the processor 1010. The system 1000 can copy data from the memory 1015 and/or the storage device 1030 to the cache 1012 for quick access by the processor 1010. In this way, the cache can provide a performance boost that avoids processor 1010 delays while waiting for data. These and other modules can control or be configured to control the processor 1010 to perform various actions. Other system memory 1015 may be available for use as well. The memory 1015 can include multiple different types of memory with different performance characteristics. The processor 1010 can include any general purpose processor and a hardware or software service, such as service 1 1032, service 2 1034, and service 3 1036 stored in storage device 1030, configured to control the processor 1010 as well as a special-purpose processor where software instructions are incorporated into the actual processor design. The processor 1010 may be a completely self-contained computing system, containing multiple cores or processors, a bus, memory controller, cache, etc. A multi-core processor may be symmetric or asymmetric.

To enable user interaction with the computing device 1000, an input device 1045 can represent any number of input mechanisms, such as a microphone for speech, a touch-sensitive screen for gesture or graphical input, keyboard, mouse, motion input, speech and so forth. An output device 1035 can also be one or more of a number of output mechanisms known to those of skill in the art. In some instances, multimodal systems can enable a user to provide multiple types of input to communicate with the computing device 1000. The communications interface 1040 can generally govern and manage the user input and system output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read-only memory (ROM) 1020, and hybrids thereof.

The storage device 1030 can include services 1032, 1034, 1036 for controlling the processor 1010. Other hardware or software modules are contemplated. The storage device 1030 can be connected to the system connection 1005. In one aspect, a hardware module that performs a particular function can include the software component stored in a computer-readable medium in connection with the necessary hardware components, such as the processor 1010, connection 1005, output device 1035, and so forth, to carry out the function.

FIG. 11 illustrates an example network device 1100 suitable for performing switching, routing, assurance, and other networking operations. Network device 1100 includes a central processing unit (CPU) 1104, interfaces 1102, and a connection 1110 (e.g., a PCI bus). When acting under the control of appropriate software or firmware, the CPU 1104 is responsible for executing packet management, error detection, and/or routing functions. The CPU 1104 preferably accomplishes all these functions under the control of software including an operating system and any appropriate applications software. CPU 1104 may include one or more processors 1108, such as a processor from the INTEL X106 family of microprocessors. In some cases, processor 1108 can be specially designed hardware for controlling the operations of network device 1100. In some cases, a memory 1106 (e.g., non-volatile RAM, ROM, TCAM, etc.) also forms part of CPU 1104. However, there are many different ways in which memory could be coupled to the system. In some cases, the network device 1100 can include a memory and/or storage hardware, such as TCAM, separate from CPU 1104. Such memory and/or storage hardware can be coupled with the network device 1100 and its components via, for example, connection 1110.

The interfaces 1102 are typically provided as modular interface cards (sometimes referred to as “line cards”). Generally, they control the sending and receiving of data packets over the network and sometimes support other peripherals used with the network device 1100. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto-processing, and management. By providing separate processors for the communications intensive tasks, these interfaces allow the master microprocessor 1104 to efficiently perform routing computations, network diagnostics, security functions, etc.

Although the system shown in FIG. 11 is one specific network device of the present disclosure, it is by no means the only network device architecture on which the concepts herein can be implemented. For example, an architecture having a single processor that handles communications as well as routing computations, etc., can be used. Further, other types of interfaces and media could also be used with the network device 1100.

Regardless of the network device's configuration, it may employ one or more memories or memory modules (including memory 1106) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 1106 could also hold various software containers and virtualized execution environments and data.

The network device 1100 can also include an application-specific integrated circuit (ASIC), which can be configured to perform routing, switching, and/or other operations. The ASIC can communicate with other components in the network device 1100 via the connection 1110, to exchange data and signals and coordinate various types of operations by the network device 1100, such as routing, switching, and/or data storage operations, for example.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method for intuitive visualization of network data comprising:
depicting at least two network events as at least two panel views, along a common time axis, wherein
the common time axis is visually represented by an extension of a two-dimensional display plane along a third mutually orthogonal spatial plane, and wherein
the at least two panel views are disposed along the common time axis in accordance with an occurrence time of the at least two network events.

2. The computer-implemented method of claim 1, wherein the at least two network events are associated with a common workflow.

3. The computer-implemented method of claim 1, further comprising:
receiving a user input; and
in response to the user input, navigating between the at least two panel views disposed along the common time axis, wherein the common time axis is bi-directionally scrollable.

4. The computer-implemented method of claim 3, wherein the navigating between the at least two panel views disposed along the common time axis is visually comparable to navigating past a plurality of billboards disposed alongside a highway, wherein the plurality of billboards and the highway represent the at least two panel views and the common time axis, respectively.

5. The computer-implemented method of claim 1, further comprising:
displaying, with one or more graphical elements, one or more causal relationships between the at least two panel views along the common time axis.

6. The computer-implemented method of claim 1, further comprising:
displaying, with one or more graphical elements, one or more constraint conditions between the at least two panel views disposed along the common time axis.

7. The method of claim 6, wherein the one or more constraint conditions corresponds to at least one of one or more deadlock conditions, one or more throughput bottleneck conditions and one or more operational dependency conditions.

8. The computer-implemented method of claim 1, further comprising:
grouping a subset of the at least two panel views into one or more subsets of related network events, wherein a relationship between the network events is a causal relationship.

9. The computer-implemented method of claim 1, further comprising:
adding at least a third panel view for at least a third network event as the at least third network event is detected.

10. The computer-implemented method of claim 1, wherein at least one of the at least two panel views have one or more color-coded tags which show if a result of a workflow was a success, a failure or a warning.

11. The computer-implemented method of claim 1, further comprising:
receiving a user input selecting at least one of the at least two panel views; and
presenting detailed information about a respective one of the at least two network events.

12. The computer-implemented method of claim 1, further comprising:
receiving a user input comprising a filtering criteria; and
displaying a subset of the at least two panel views that match the filtering criteria.

13. A system comprising:
one or more processors; and
at least one computer-readable storage medium having stored therein instructions which, when executed by the one or more processors, cause the system to:
generate two or more panel views corresponding to two or more network related events, wherein at least one panel view has one or more textual and graphical elements for conveying one or more descriptions for a respective one of the two or more network related events;
display the two or more panel views, along a common time axis, wherein the common time axis is visually represented as an extension of a two-dimensional display area along a third mutually orthogonal spatial dimension;
dispose the two or more panel views, along the common time axis in accordance to an occurrence time of the two or more network related events; and
depict one or more temporal relationships among the two or more network related events by using one or more visual indicators between the two or more panel views disposed along the common time axis.

14. The system of claim 13, wherein the common time axis is bi-directionally scrollable.

15. The system of claim 13, wherein the one or more descriptions comprise information regarding one or more work flows associated with the two or more network related events.

16. The system of claim 13, further comprising instructions which, when executed by the one or more processors, cause the system to:
navigate along the common time axis between the two or more panel views in response to a corresponding user input.

17. The system of claim 13, further comprising instructions which, when executed by the one or more processors, cause the system to:
display one or more causal relationships between the two or more panel views disposed along the common time axis.

18. The system of claim 13, further comprising instructions which, when executed by the one or more processors, cause the system to:
display one or more constraint conditions between the two or more panel views disposed along the common time axis.

19. The system of claim 18, wherein the one or more constraint conditions corresponds to at least one of one or more deadlock conditions, one or more throughput bottleneck conditions and one or more operational dependency conditions.

20. The system of claim 13, further comprising instructions which, when executed by the one or more processors, cause the system to:
receive a user input selecting at least one of the two or more panel views; and
present detailed information about at least one network related event associated with at least one of the two or more panel views.
